(19) United States
(12) Patent Application Publication
(10) Pub. No.: US 2016/0071165 A1
(43) Pub. Date: Mar. 10, 2016

(54) SYSTEM AND METHOD TO EVALUATE, PRESENT, AND FACILITATE THE ADVERTISEMENT AND PURCHASING OF PRODUCTS AND SERVICES BASED ON THE EMOTION EVOKED IN A RECIPIENT UPON RECEIPT OF THE PRODUCT OR SERVICE

(71) Applicant: Tech 4 Profit, LLC, Austin, TX (US)

(72) Inventor: Sheri K. Osborn, Austin, TX (US)

(73) Assignee: TECH 4 PROFIT, LLC, Austin, TX (US)

(21) Appl. No.: 14/943,825

(22) Filed: Nov. 17, 2015

Related U.S. Application Data
(63) Continuation of application No. 13/653,845, filed on Oct. 17, 2012.

(51) Int. Cl. G06Q 30/02

(52) U.S. Cl. CPC G06Q 30/0269; G06Q 30/0273

(57) ABSTRACT

A method of quantifying and attaching the emotional state of receiving a product or service purchased online so that a buyer who lacks history with a particular product or service can be assured of satisfaction with by that product or service because of emotional satisfaction ratings from all purchasers of the same demographic, which also provides advertisers great feedback on the likelihood of advertising of that product to that demographic leading to a product purchase so therefore generating an advertising fee based on the ranking of emotional state change each product/service provides the end user.

### BACKGROUND OF THE INVENTION

There have been many studies to understand buying behavior. These studies are based around neuroscience, the psychology of the buying process and market research. Satisfaction with a product decision is highly influenced by emotional impact. Students in marketing, advertising and sales training are repeatedly trained to promote benefits not features.

So far, the science of buying behavior tells us that people have developed a few strategies to aid in their buying process most of which are based on their information processing capabilities (what they can see and learn) or what they already know (historical).

When walking around a department store to select a gift for another demographic such as a child, a buyer can go to a toy department and choose from the toys they see in front of them. They make a series of comparisons based on a variety of indicators such as how much they want to spend, their own preferences (such as avoiding violence) then narrow all of the items to the one they purchase hoping to at least meet or exceed the expectations of the recipient. This process is boiled down to choosing from a list of known alternatives which is useful when you are in a department store and can walk through the toy department.

The next option a buyer may take into consideration is their personal experience. According to Lynch, Marmorstein and Weigold, many shopping tasks are performed by historical data such as seeing a few televisions in one store at a mall then buying one of them from a different store. Or consumers may use a positive experience with the brand such as always choosing to stay at an Embassy Suites Hotel® (a registered trademark of Hilton Hospitality, Inc.) because of past experience with Embassy Suites Hotel®.

Another strategy is to choose from what the buyer understands of another recipient's experience. For example, if a buyer has purchased a similar item for a different person and achieved the desired emotional response, then it stands to reason that the same item may elicit a similar response for a demographically similar recipient.

Similarly a buyer could seek for the recipient to get the same emotional response that the buyer received from a similar purchasing experience. The similar purchasing experience is shaped by each recipient's emotional make-up, culture and background as well as the various features of the products. All actions and processes that are involved, such as physical actions and perceptual and cognitive processes (e.g., perceiving, exploring, using, remembering, comparing, and understanding), will contribute to the buying decision which presumes that the intended recipient for a purchase thinks, feels and processes information as understood by the buyer.

The obvious problem occurs if the purchaser has different demographics from the recipient (e.g. the purchaser is a different gender or does not have experience with the products for a particular demographic). For example, a grandparent needs to buy a gift for a 10 year old. Many of the current electronic toys and Internet games were not available during the childhood of the grandparent so the grandparent has little basis for making a buying decision.

This task becomes even more daunting when the purchase is from an e-tail store site (e.g. an internet based retailer). Upon entering an e-tail site, users typically are offered a few advertisements of that site's specials or new arrivals and more sophisticated sites offer alternatives based on the user's personal buying preferences or random selections. Otherwise, the user is provided a blank “search” box which means:

The user must have a good idea of what they are shopping for before they use the e-tail site.

There is not a feature to help them understand a particular demographics' response to this or that item except perhaps reading reviews hoping to glean feedback from a similar demographic after they select a product.

The user needs an easy way to be able to enter the demographic of the purchase and the emotional response desired and be provided with a selection of all products and services available at the e-tail site that have a proven record of a similar response from that particular demographic.

Therefore, there is a need for a solution which addresses these and other shortcomings of existing systems.

### BRIEF DESCRIPTION OF THE INVENTION

The disclosed subject matter will forever change the nature of research and development for products. Currently there is no universal system to compare a product inside the universe of all products under consideration even beyond the product category, for a demographically related emotional response elicited in the recipient of the product. Traditionally, a perfume manufacturer would compare its perfume to other perfumes or colognes; however, with the disclosed subject matter, the perfume manufacturer would also have the ability to compare its perfume against other products which evoke similar emotional responses in the recipient (e.g. jewelry, flowers, lingerie, etc.). The perfume manufacturer could then repackage or redesign the perfume to gain ground on those “competitive” purchases (e.g. make the perfume bottle look more like jewelry or crystal). Further, this can make identifying the elasticity of the price buyers are willing to pay within a particular demographic and emotional “band” significantly easier, consequently allowing the perfume manufacturer to change its price structure. In a general sense, the disclosed subject matter provides product manufacturers access to different product development directions because the disclosed subject matter helps manufacturers gain additional insight into the rationale of purchase decisions made by buyers on behalf of product recipients.

The foregoing is accomplished by creating a method/system to easily score user satisfaction data based on the emotion elicited in the recipient—the “emotional value” the product carries in a particular demographic and permitting the products and services to be selected based on this emotional value. The method/system aggregates and measures the emotional effect a product or service will have on a particular demographic and present this emotional effect in an easy to use way for the public at large. This solution will help ensure a particular product will satisfy both the purchaser's and recipients emotional goal.

For example, a Husband wants to buy a gift for his Wife to lift her spirits after a difficult time. Until now, the only data the Husband had available to him is his known experience—i.e. the Husband has purchased the same product or service for his Wife in the past. Spending hours entering a variety of items in the search box the Husband still may select an item and be greeted with a lukewarm response from his Wife. Consequently, neither the Husband nor the Wife received the positive emotional benefit expected from the purchase. In another example, with this solution, grandparents can enter their grandson's demographics and be provided with a large list of gifts that have proven to satisfy this demographic from which they can add their knowledge of their grandson to select the gift that causes him great satisfaction.

Web-based e-tail stores flourish on the Internet. According to Forrester, by 2014 the web will directly account for 8% of U.S. retail sales and influence 53% of consumer purchases. Currently e-tail stores carry hundreds of millions of products. Amazon offers more than a billion product choices. This process will help buyers make less stressful, easier, more informed purchase decisions from a greater variety of options and help avoid disappointment with product/service choices.

### SUMMARY OF THE INVENTION

One purpose of the present disclosure is to simplify a very common purchase desire: the desire to change a recipient's emotional state. It allows the buyer to input the desired emotional outcome of the recipient upon receipt of the product or service. The buyer is provided with the products and services that are recommended by the product's creator and by previous customers to have the same reported emotional value attached to the product.

In one example, a buyer may desire a purchase to cheer up a sad friend. The buyer would select the emotional characteristic “cheer” and would be presented with a number of products and services designed and/or reported by previous purchasers/recipients as eliciting cheer in the recipient. In an alternate example, a buyer may desire a product that encourages them during a trying period of time. The buyer would select “encourage” and would be presented with a variety of products and services designed by the manufacturer to encourage and/or reported by previous purchasers/recipients as encouraging them.

At the core of any product's brand identity is some emotional value. The American Marketing Association defines a brand as a “Name, term, design, symbol, or any other feature that identifies one seller's good or service as distinct from those of other sellers.” One key distinction within a brand of a product or service is the emotional value it provides the recipients. One purpose of this system/method elicit, name and measure the emotional value a product carries for the purpose of trading or transacting business. This brings “brand” closer to a person's desired emotional outcome minus the particulars of the product or service. Many buyers want to purchase a good or service based on the desired emotional outcome for the recipient of the product or service and the particulars of the product or service is of less interest. E-tail shopping becomes easier as the buyer can hone in on the desired emotional outcome within the recipient without going through mental gyrations as to, for example, which product will better cheer up a person: a lively music CD, a bouquet of flowers or a new hat? An embodiment may rely on the intent of the maker, the frequency of purchases by other people and the reported emotional impact/outcome from users who have purchased and/or received each item.

This “value” will carry over into the advertising pricing scheme. Manufactures desire to quantify that the dollars they spend on advertising results in brand awareness and ultimately, increased sales. Using an e-tail website search now returns a few products in sponsored advertisements or banner advertisements followed by sometimes hundreds of products from each query. The search engine fees/banner ad fees paid to the owner of the search engine/e-tail site stay low because of the low conversion/sale rate (e.g. the difficulty of linking a product appearing in the search query with any of the buyer's desires for the purchase).

A benefit of the present disclosure, particular embodiments of the scoring system, is that as products improve in Score the buying predictability will also improve. A consumer product manufacturer can analyze the aggregate score (emotional value) obtained over the life of a product by demographic as compared across similar and dissimilar product categories. The manufacturer gains insight in ways to innovate and improve products and/or create new products. A product or service that has a high score may have the larger advantage over similar products that have a lower score. This will provide impetus to manufacturers to please customers. Once this value is quantified, it can be transferred from the e-tail store advertising to any other marketing effort of the manufacturer—similar to the way the Good Housekeeping Seal™ (a trademark of Hearst Communications, Inc.) becomes part of the marketing effort for a product. The higher the score the more likely the product will be purchased. This value could then be translated into higher prices for the advertising and banners purchased by the manufacturer. An additional value of the score is that manufacturers can review the scores of their products and the emotional ranking score reported by the recipients to understand more about what customers value in the manufacturer's products. The score simplifies something that manufactures struggle to understand at this time: “what is going on in the head of a potential buyer before they purchase my product?” Knowing this information provides the manufacturer with valuable information about new features for the product, product changes or even additional product derivation.

According to an exemplary embodiment, a method of scoring the emotional value (quantifying an emotion such as cheer, encourage, love, friendship) of a product or service is shown. This method collects the desired emotional value from the manufacturer/service provider which is stored with the product in the e-tail inventory database. If the product's emotional value isn't known, that value can be appraised from past purchasers of the product or service. That emotional value characteristic is used in conjunction with other characteristics including frequency of purchase and additional feedback from customers. This allows products to be segmented by the kinds of emotions they offer and ranked against all products and services that offer a similar emotional value.

According to a second exemplary embodiment, a method of delivering products and services to buyers based on the desired emotional delivered to the recipient per desired demographic. The buyer informs the system of the intended recipient's demographic and desired emotional state after the purchase and receipt of the product, and the system responds with all products that are designated to deliver that emotional response for that demographic. The products could be ranked by popularity, including which is selected most often generally, which is selected most often to elicit the desired emotional response, which is reported as eliciting the desired emotional response upon actual receipt, etc.

According to a third exemplary embodiment, a method of dynamically setting advertising prices is shown. The method includes using the score to establish advertising prices because the higher rank offers a clearer return on investment (ROI) on the dollars spent on the advertisement. If an advertisement has a 100% sales response rate, that advertisement is more valuable than an advertisement with a lower response rate. Knowing the desired emotional state of a buyer before their purchase increases the value of advertisements directed to products or services which elicit the desired emotional response thereby increasing the likelihood of a purchase. This also has the additional benefit of lowering the return rate for products (e.g. if the recipient likes the product or service because it elicits the desired emotional response, it is significantly less likely that the purchaser or recipient will return the purchase).

This summary and the following detailed description are directed to certain specific embodiments of the invention. The invention is not limited to the particular embodiments and applications described herein. The invention is defined only by the claims.

### BRIEF DESCRIPTION OF THE DRAWINGS

FIG. 1 is an illustration of one embodiment detailing a simplified purpose of the invention.

FIG. 2 is an illustration of one embodiment of the color codes for emotional descriptors and examples of the specific emotional responses to a product that could be associated with each color.

FIG. 3 Components of the interaction between users and the system.

FIG. 4 is an illustration of one embodiment of the product coding process.

FIG. 5 is a list of one embodiment of negative emotions which the recipient could be experiencing to guide the buyer to the best emotionally matched product.

FIG. 6 is an illustration of a web-based interface that allows a user to select different emotional outcomes for different demographics of users, by gender, by age, etc., according to an exemplary embodiment;

FIG. 7 is a chart of the emotional state scoring elements and how the emotional scores are aggregated so that the products that have the “right” and most measurable emotional impact rise to the top.

FIG. 8 is an illustration of a web-based interface that allows a recipient to score emotional outcomes by comparing before and after feelings, according to an exemplary embodiment to confirm and measure the aggregate emotional value of a product;

FIG. 9 is a chart illustrating an exemplary embodiment of a product database with scores delineating per demographic the products that most successfully convey the emotion.

FIG. 10 is a chart illustrating the aggregate desired emotional outcome score according to an exemplary embodiment per one emotion value (love) for one demographic.

FIG. 11 is a diagram that illustrates the aggregate emotional scores stored in a database attached to the e-tailer's product inventory database, according to one exemplary embodiment.

FIG. 12 is an illustration of the flow of information between a user, the e-tail web site, the inventory database and the emotional score aggregation according to one exemplary embodiment.

FIG. 13 is an illustration of the information stored by the e-tail vendor which could include information about the inventory, the emotional ranking score and the advertisements and associated advertisement data, according to one exemplary embodiment.

FIG. 14 is an illustration of the process to dynamically score the emotional value of each product purchased and filter such that scores are only included when the product delivers the right emotional response, according to one exemplary embodiment.

FIG. 14A is an illustration of the process from its beginnings at the level of the manufacturer through the emotional scoring system method. The outcome is that products can be advertised with a score that offers buyers insight into how much emotional power is conveyed per demographic in selecting and giving a gift to a recipient according to one exemplary embodiment.

FIG. 15 is an illustration of the process to dynamically price advertisements based on a product's aggregate score the product earned by most successfully conveyed the desired emotional response recipient per that demographic as compared to all of other products that convey that emotion according to one exemplary embodiment.

### DETAILED DESCRIPTION

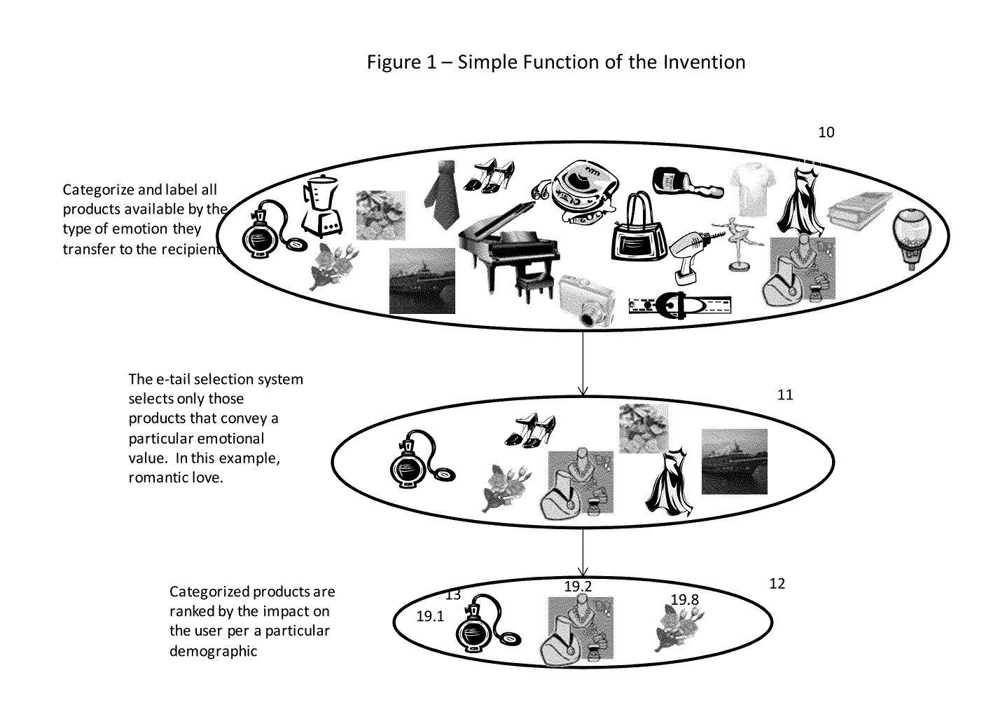

FIG. 1 is an illustration of one embodiment detailing a simplified purpose of the present disclosure. According to this embodiment, an e-tail vendor potentially has millions of products in inventory 10. An embodiment the present disclosure may include a categorization function, wherein products or services are categorizing by the perceived emotion evoked when a recipient receives the product. An embodiment in response to an e-tailer's search engine create a subset of products 11 for presentation to a buyer that are categorized as eliciting the particular emotion selected by the purchaser. In this particular example, romantic love is shown. From this subset of products, the buyer can see many kinds of products which are perceived by embodiments of the present disclosure to convey the emotion they desire to invoke in the recipient. An embodiment may employ a numeric score algorithm, which aggregates the impact score from prior recipients who have received the product is displayed to the buyer. In this particular example, perfume has a score of 19.1, jewelry has a score of 19.2, and flowers have a score of 19.8.

In a more complex embodiment, ranking may account for the recipient's demographics. For example, a particular product may have a different score for a 16 year old female than for a 40 year old male. In yet another embodiment, the demographic of both the recipient and purchaser may be taken into account. For example, a 50 year old male purchasing something for his 30 year old daughter would want a different listing of products than if he was purchasing something for his 30 year old girlfriend and so relationship could become part of the product query. Regardless of the particular embodiment, all of these aim to reach the same goal—reduce the chance a product or service that is poorly received by the recipient. These more complex embodiments are discussed in further detail below.

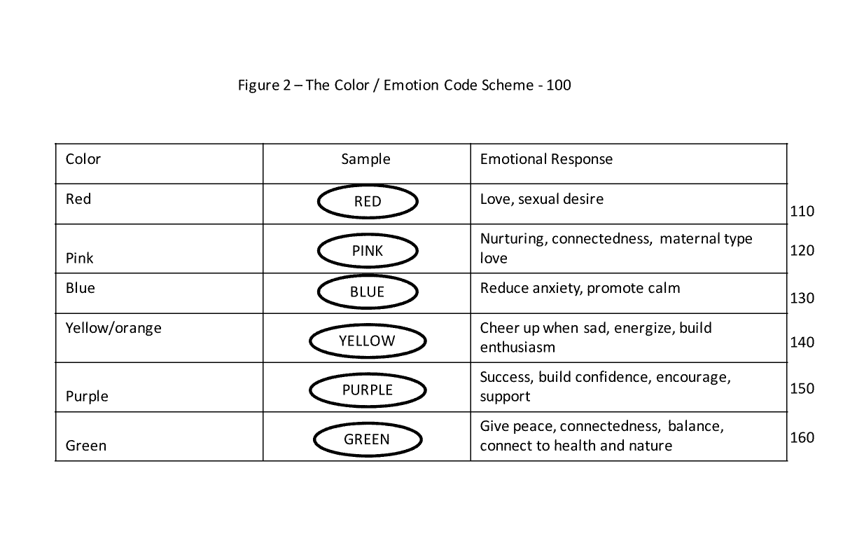

FIG. 2 is an illustration of one embodiment that employs color codes for emotional descriptors and, examples of the specific emotional responses to a product that could be associated with each color 100; the color code makes the system easier to understand and use. The color scheme in this particular embodiment contains colors that associated with certain psychological emotional states. In one embodiment, buyers could simply look for this universal color code on the label or price tags of products in a brick and mortar retail store or in the product description for an e-tail store. According to this embodiment, buyers that wish to covey romance 110 would seek the red indicator for romantic love as the emotion contained in the product purchase. In this embodiment, brotherly love or nurturing love would be conveyed by the color pink 120. The color blue would convey a calming emotion 130; the color yellow would convey emotional that cheers a recipient 140; the color purple would be the color of encouragement 150 while connectedness to nature would be conveyed by the color green 160. It is important to note that other colors could be employed as well as additional granularity could be achieved by further subdividing the psychological emotional states and associating those additional psychological emotional states with additional colors.

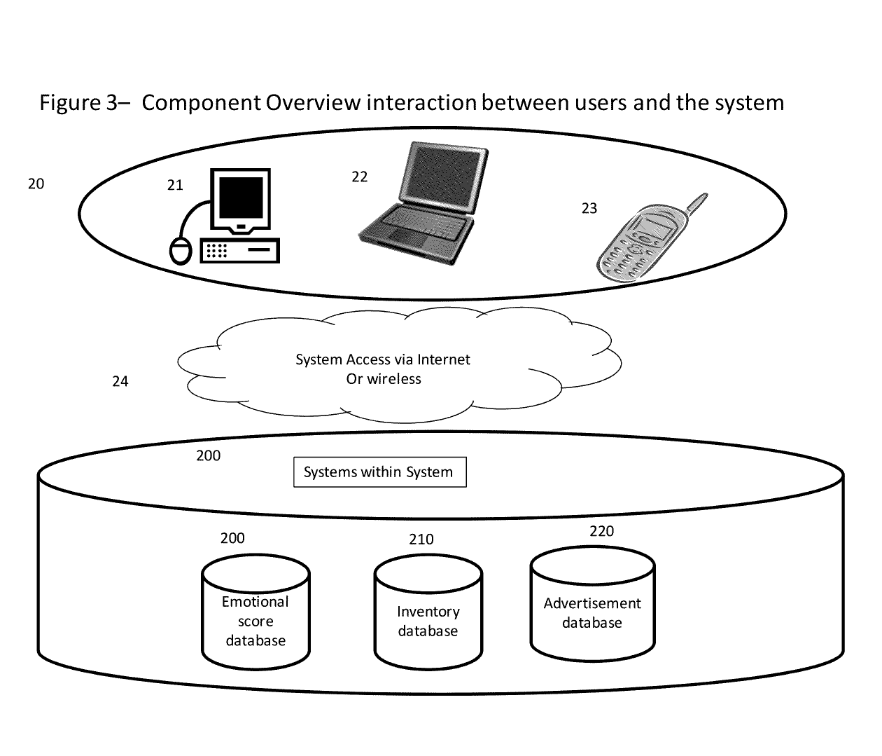

FIG. 3 presents an embodiment of the present disclosure and interactions that may occur between the users and the computer servers within the e-tail store. A user may access the e-tail store through a computer device 20, for example but not limited to a PC 21, laptop 22, cellular/smart phone 23, tablet, or other communication enabled device. The user would connect to the e-tail store via an available communications medium such as the Internet or Wi-Fi 24. The user may then submit their desired emotional value (e.g. cheer, love, etc.) via the communications medium to the e-tail store. The e-tail store may search an inventory database 210 which contains all the products and services offered for sale and an associated emotional score database 200 to identify the particular products and services which most closely match the indicated emotional value (e.g. the emotional response the user/purchaser desires to evoke in the recipient). An embodiment may employ additional databases could include an advertisement database 220 which contains and manages advertisements which are displayed on the user's screen as they shop at the e-tail store. Although discussed as three databases, one or more of the foregoing could be implemented in one or more databases as the particular needs of the e-tail store dictate.

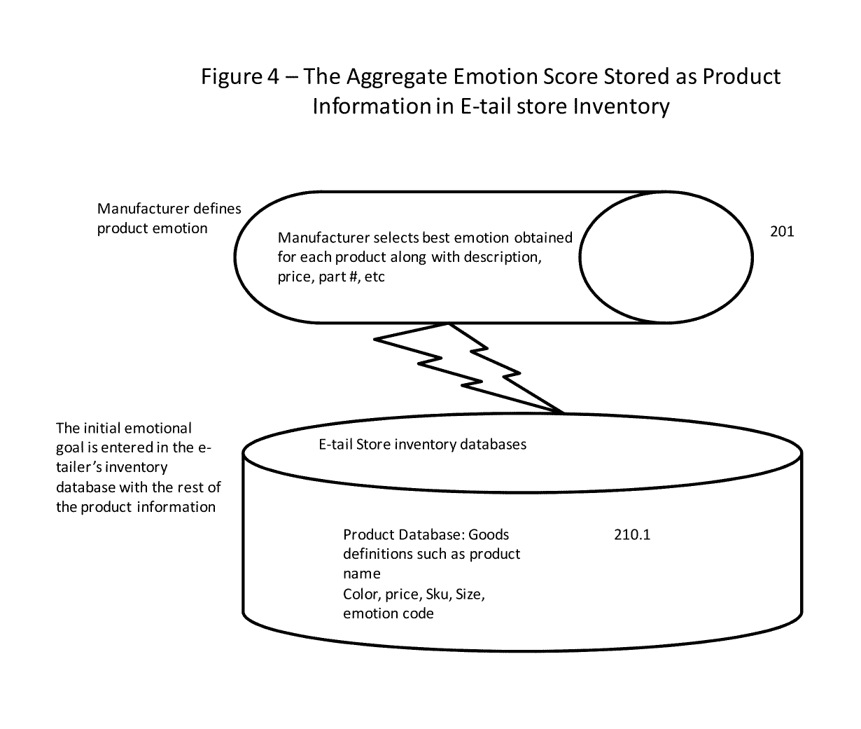

FIG. 4 is an illustration of an embodiment of the product coding process. A manufacturer 201 may select an emotional effect the a recipient may receive from the product or service

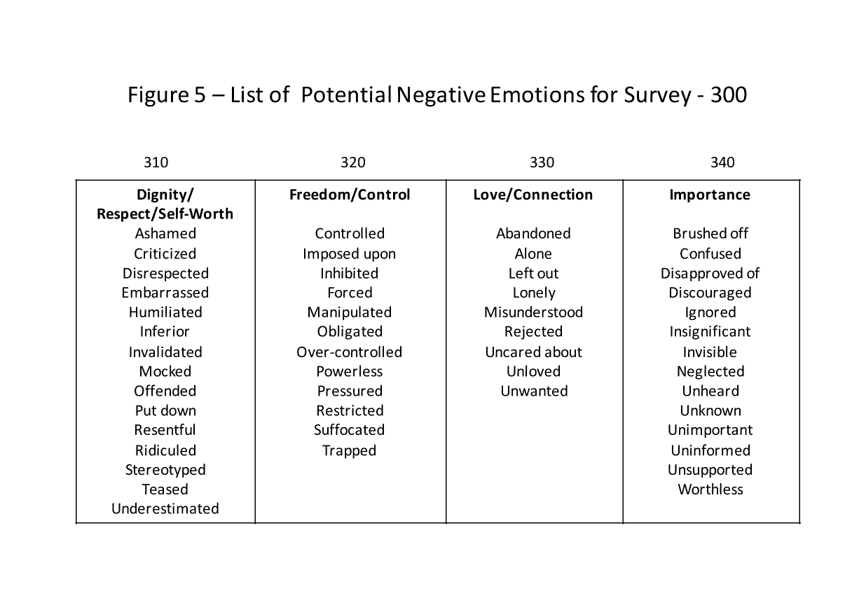

FIG. 5 presents a list of exemplary negative emotions 300 that embodiments of the present disclosure may be utilized to source one or more product purchases for mitigating or negating. Because the buyer may desire for the recipient to have a positive emotion once they receive the item purchased, the buyer using the present disclosure may input information about the perceived negative state(s) of the recipient as input prior to the purchase. Some categories of negative emotions in this embodiment include: Dignity Emotions 310 such as feeling embarrassed or humiliated. Negative emotions associated with freedom and controls 320 are powerless, pressured and trapped. Some of the negative emotions attached to love and connection 330 are rejected, misunderstood and lonely. Some of the negative emotions attached to importance 340 are insignificant, neglected, and unimportant. By selecting the negative emotion, the system could provide products or services that counteract the negative emotion.

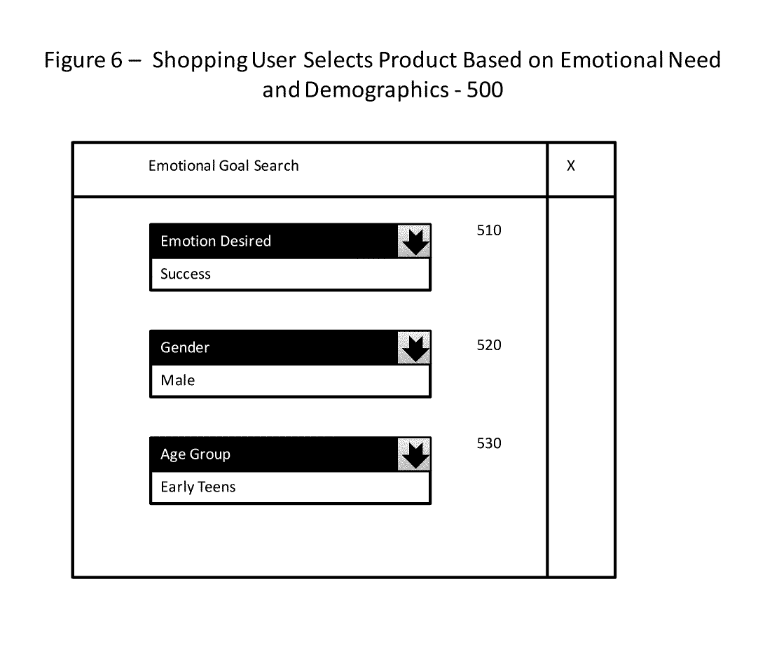

FIG. 6 illustrates an exemplary web-based interface as employed by embodiments of the present disclosure. As shown, this exemplary web-based interface may facilitate a user selecting different emotional outcomes for different classes of users, by gender, by age, etc. In contrast to the present disclosure, a buyer using existing technology has to guess which product out of all products that are in the particular vendor's inventory (including products available through a particular e-tailer's website offered for sale by other merchants), will bring about the most desired emotional value to the recipient. An embodiment, through use of a user interface 500, provides buyers with an opportunity to select the emotion desired for the recipient 510. Furthermore, an embodiment may allow for further filtering of product or services for a desired emotion by comparison of demographic information 520, 530 of the recipient to aggregated data. An embodiment may then returns to the buyer products available from the e-tail store that have a threshold aggregate score for that desired emotion for that demographic information. By way of example only, embodiments may include demographic information such as geographic location, religious affiliation, hobbies, sexual preference, height, weight, dietary constraints, allergies, etc.

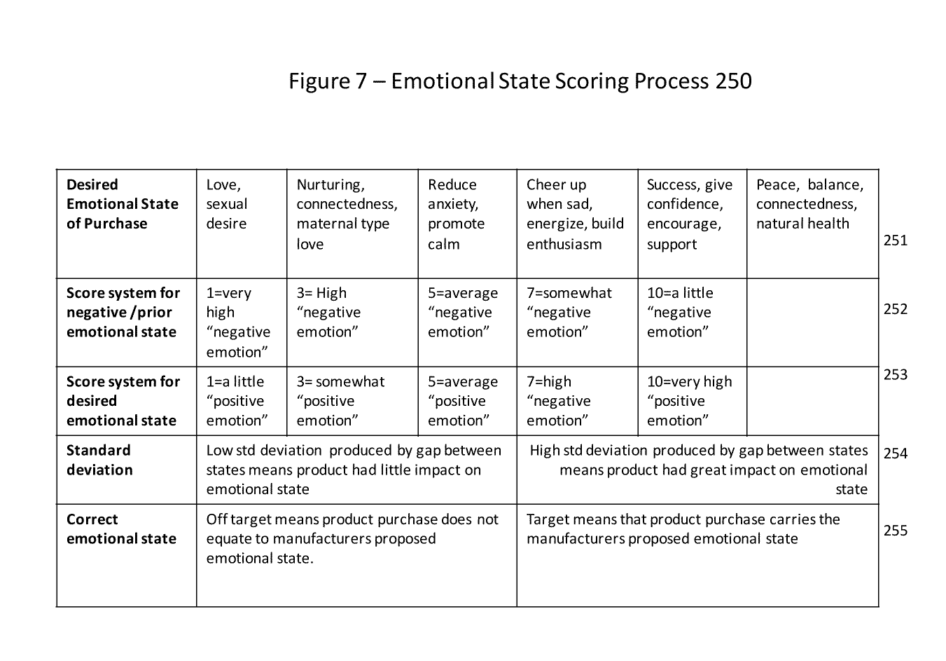

FIG. 7 presents an exemplary definition chart for each element for an emotional state scoring 250 as may be employed by an embodiment of the disclosed subject matter. As shown, a first category may be the Desired Emotional State of Purchase 251. This field describes the emotion that the purchaser desires to evoke in the recipient when the recipient receives a product. The next category is the score applied to the negative or prior emotional state of the recipient 252. This score measures the initial negative emotional state of the recipient which buyer is supposed to positively impact with the purchaser. To put this another way, this score is the relative level of the recipient's negative emotional state prior to receiving the purchase (e.g. the recipient could be very anxious; a little sad; etc.). The next category is the positive emotional score the recipient experiences after having received the product 253. To put this another way, this score is the relative level of the recipient's positive emotional state after receiving the purchase (e.g. very loved; mildly calmer; etc.). The next category of information is the standard deviation between the negative or prior emotional state score and the positive or receiving emotional state score 254. The purpose of the score is to show the delta of the impact on an emotional state. For example, a recipient with a negative emotional state of very sad that receives a purchase which changes their emotional state to very happy has a large impact on the recipient's emotions. Conversely a negative emotional score of 3 which moves to a positive emotional score of 1 shows less impact on the emotional state of the recipient. The category called correct emotional state tracks the emotional state the manufacturer believes should occur when the product is received vs. the emotional state that actually occurs when the recipient is queried as to the emotional state the product evoked in the recipient when the product was received by the recipient 255. It is intended that other emotional states, scoring levels and/or descriptors, and statistical analyses could be employed and remain within the scope of this disclosure.

An application of the present disclosure for a necklace with a heart on the chain may be as follows. Initially, a manufacturer offering the necklace may submit to the system that necklace will invoke in recipients “romantic love”. However, aggregated data on historic purchases of the necklace may show that recipient demographic is predominantly children. Accordingly, an embodiment on comparison of the aggregated data versus the initial input may determine that the the score for invoking value “romantic love” to be low, negative, non-existing, and may instead determine that the product has a high score for an invoking value of “nurturing.” In on embodiment, the conflict between a manufacturers's perceived invoking value and an aggregated score or value may be presented to a manufacturer. Manufacturer may be required to alter the demographic of a product marketing, may alter the invoking value through changes to the input, or may alter packaging or make other changes so that a manufacturer is clear on the most likely desire for the purchase of the product. Additionally or alternatively, the manufacturer could redirect advertising funds towards alternate markets.

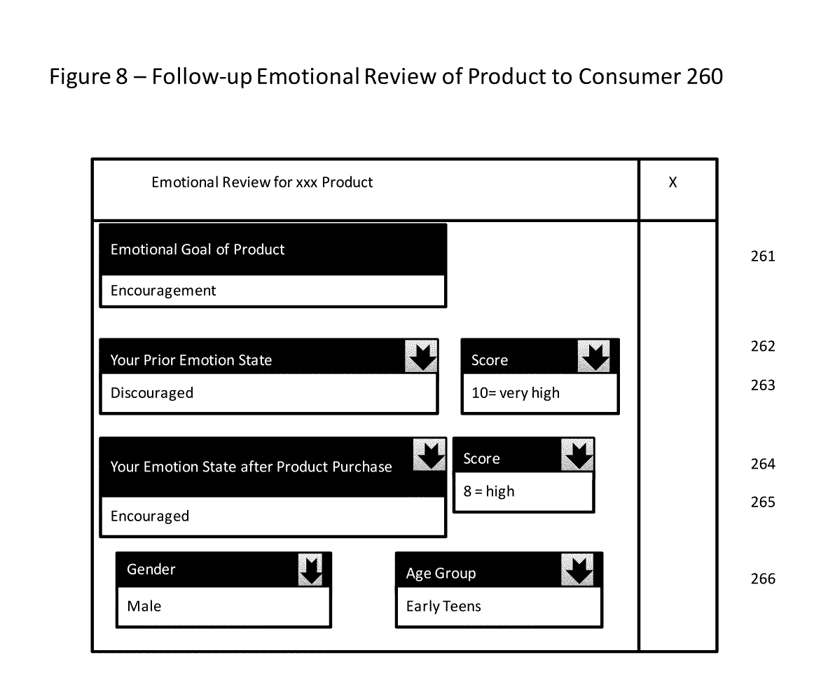

FIG. 8 illustrates an exemplary of a web-based interface 260 that may be employed by embodiments of the present disclosure to collect recipient information after the recipient has received. Here it is called a Follow-up Emotional Review of the Product. An embodiment may collect both a recipient's initial emotional state 262 and a measurement of this state 263 prior to receiving the product are collected. Alternatively, an embodiment may collect only the initial emotional state. An embodiment may collect the recipient's emotional state after receiving the product 264 and 265. An embodiment may then collect Demographic data 266 for correlation by the system against emotional impact for categorization by, for example, gender, relative age of the recipient, etc. An embodiment may include a unique identification number for the product or service (e.g. on the shipping receipt, etc.) to identify not only the particular product or service provided to the recipient, but also could allow the demographic and emotional info entered by the purchaser to be matched with that of the recipient.

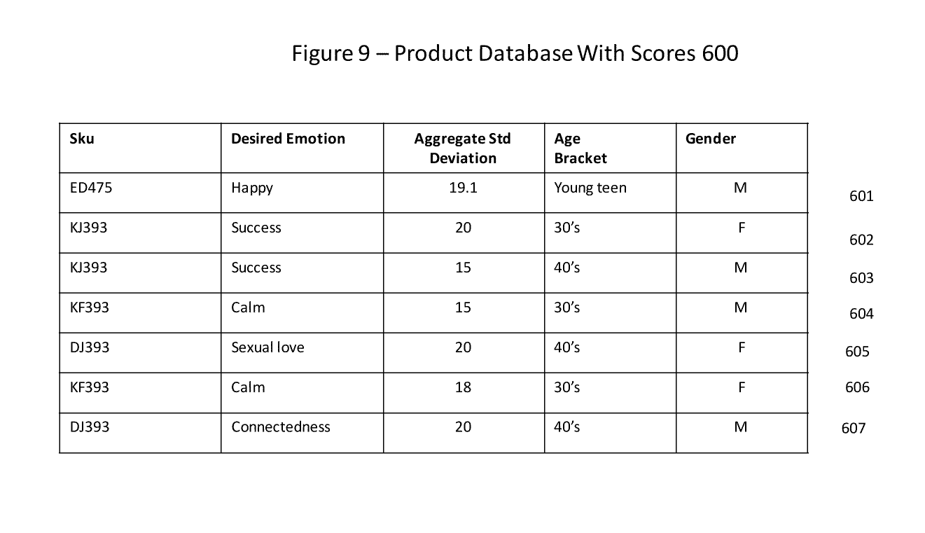

FIG. 9 illustrates an exemplary aggregate emotion score as may be employed by embodiments of the present disclosure as it is stored along with product/inventory information 600. The inventory system for an e-tail store typically contains a variety of information about each product. For example, one inventory database would contain the product name, the manufacturer, the SKU number and the product's price which are all pieces of information that describe the particular product. Other databases track information on the status of products such as inventory levels, shipping information, order processes and timeframes, etc. A embodiment of the present disclosure may incorporate an emotional value and aggregate score for each product into a database similar to the above. The illustrated exemplary may track the particular emotion conveyed and the aggregate score for every product in the e-tail store's inventory. As shown in this example, the product ED475 scored very high, 19.1, meaning that the system through analysis of aggregated results received from teen aged males who received the product entered inputs to the system correlated to a large impact on them (e.g. making them very happy) 601. Further as shown, the system identifies a high impact score for productQKJ 393 for a demographic of females who are in their 30's 602. This contrasts with the lower impact score for the same product for a demographic of males aged in their 40s 603. Further outputs from this embodiment include: product KF393 having a greater impact on females 606 aged in their thirties compared to males in the same age 604; productDJ393 recorded a very high scores for the demographic of females 605 in their 40's and the demographic of men in their 40's 607, but for different desired emotions.

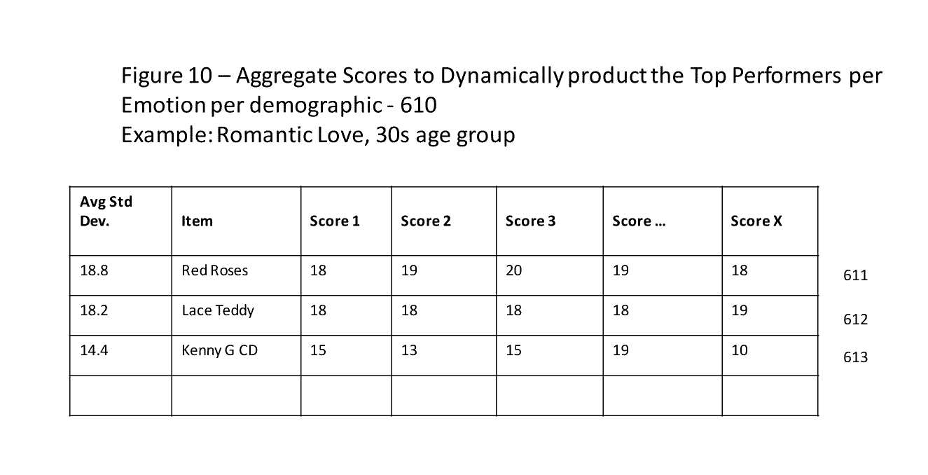

FIG. 10 illustrates an embodiment that may aggregate the desired emotional outcome score 610, and prioritize presentation of products with the highest emotional change score for a particular emotion and a particular demographic group. In the example shown, an embodiment receives inputs from a user querying for products that may elicit romantic love for a demographic limited by an age range between 30 and 39. An embodiment responding to this query may filter for scores meeting a threshold requirement of all products that are noted by the manufacturer, and/or reported by recipients, as delivering the emotion of romantic love to the recipient. In an embodiment, a scoring system determine the most impactful products by employingemploy a standard deviation calculation between the negative emotions and the positive emotions of the recipient to further filter products present to potential buyers so as to prioritize presentation of most impactful products for conveying romantic love for the selected demographic. As shown in this example, the red roses were recorded by an embodiment employing the present disclosure to have a greater score 611 compared to a teddy having a similar but slightly lower impact score 612. Through use of the present disclosure, a buyer may therefore be able to deduce from the relative similarity in scores that either of these gifts would have a similar impact on the recipient.

A benefit of an embodiment that employs a scoring system of the present disclosure includes providing users with greater understanding of the impact of the gifts they select for a recipient. But more than this, the scoring system enhances the shopping experience because the buyer is informed of high scoring products from the collective of everyone who has shopped for a gift for this demographic. The buyer should see many gifts which carry a great deal of emotional impact of which they may be completely unaware. With this, a Husband could have many successful surprises for his Wife over the course of their marriage. As his Wife ages, his gifts are continually refined and tailored through the emotional impact for her demographic.

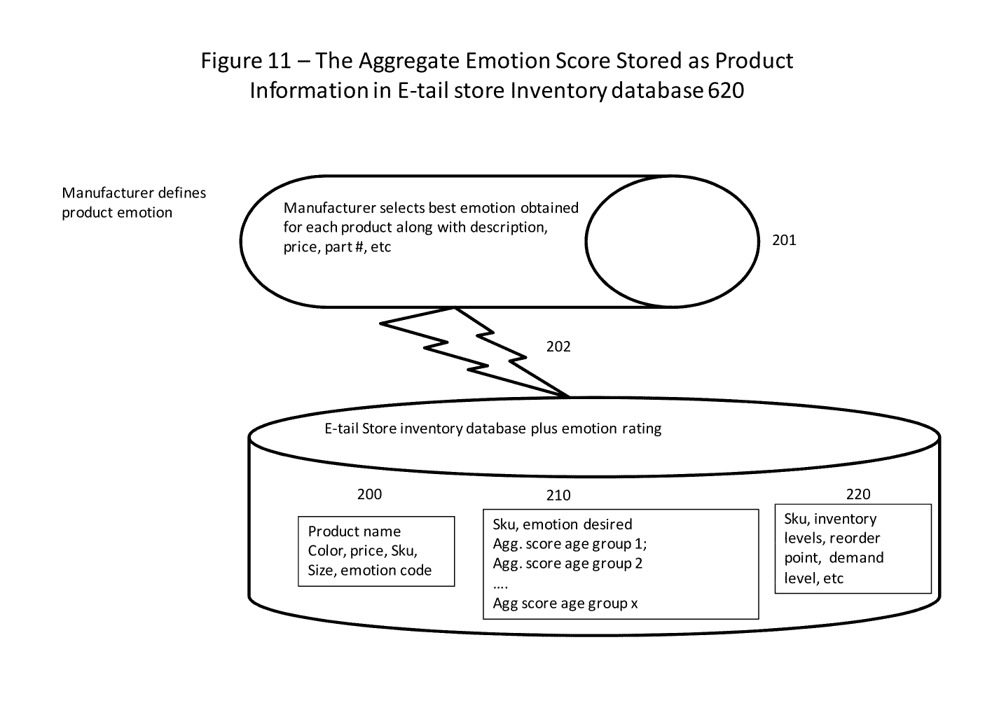

FIG. 11 illustrates an exemplary physical server systems of the present disclosure that may be employed to create and track the emotional scores from the point of the manufacturer to the inventory of an e-tail store 620. When a product is manufactured, an embodiment may be configured to receive input from a manufacturer selecting an initial emotion value such as calm, romantic love, comfort, etc. which may be attached to that particular product in the same way the manufacturer inputs the description, the size, the manufacturer's suggested retail price and the cost of the product 201. In one embodiment, the manufacturer may select multiple emotional values for different demographics. This information may be transmitted 202 to e-tail store's databases that manage the store's inventories such as a product database 200 and the supply chain and ordering information database 220. An embodiment may also employ a further database, or could be incorporating in the first database, for tracking each product's emotional score at the same through use of recipient's Follow Up Emotional Review of the product 210.

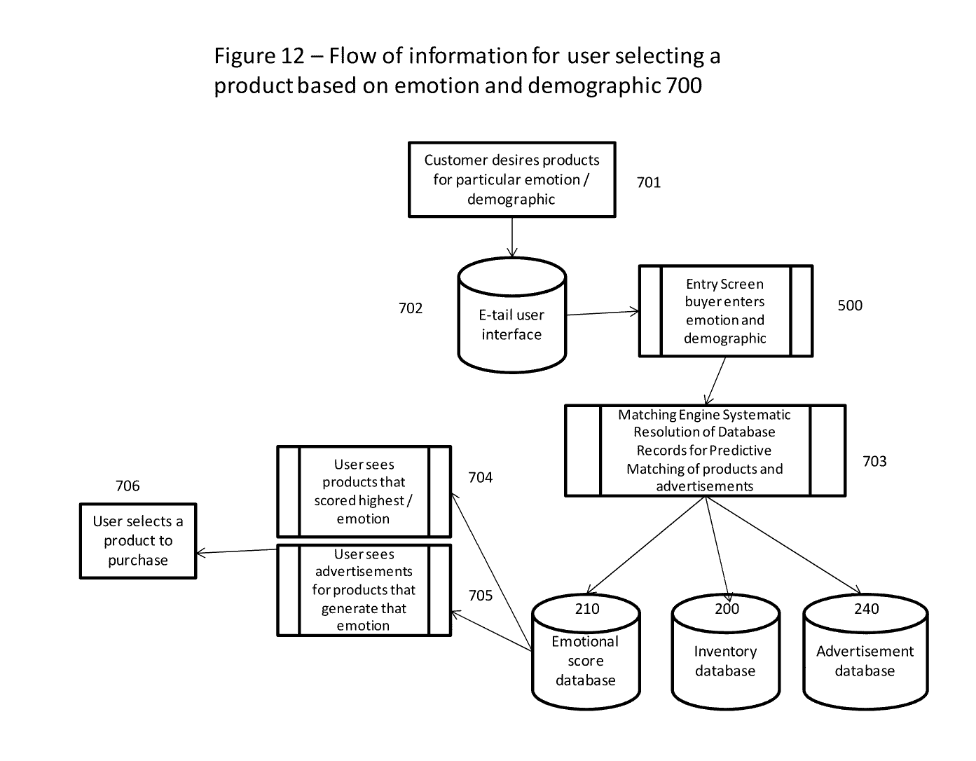

FIG. 12 illustrates an embodiments flow of information arrangement between a user, the e-tail web site, the inventory database, and the emotional score aggregation 700. In this exemplary embodiment, a buyer desires to purchase a product, which will evoke a particular emotion to the recipient of the product 701. The ordering system from the e-tail store may provide an online interface that allows the buyer to enter demographics information about the recipient. For example, info related to age, sex, and the emotion the buyer would like the recipient to have upon receiving the product (e.g. a feeling of success or a feeling of being nurtured) 500, etc. An embodiment employing a search engine may take this information and query an e-tailer inventory database 200 and 210, and may to identify and rank all products that are returned with scored meeting threshold requirements for the emotional response and demographic selected. Additionally an embodiment employing a search engine may connect to the advertising database to identify one or more advertisements correlating with buyer info, including but not limited to buyer inputted demographics, as well as metadata, etc. related to buyer, and the desired emotional response 240. An embodiment may present to buyer products that scored highest for the emotion and demographic entered 704. An embodiment may present to buyer advertisements that correlate to the desired emotion for the entered demographic 705. From this group the buyer through interaction with embodiments of the present disclosure may select and purchase the desired item 706.

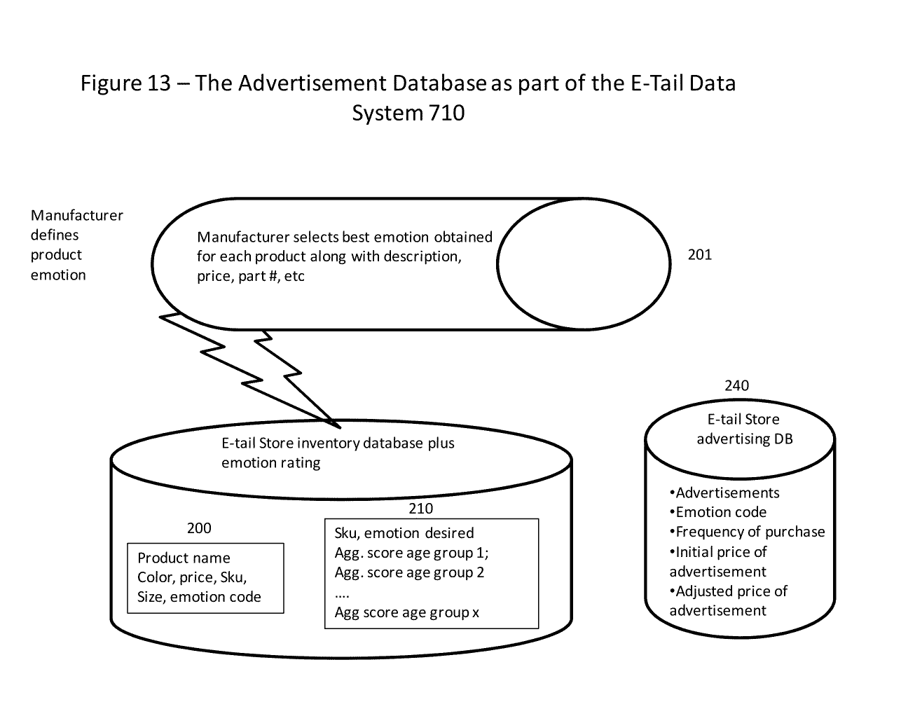

FIG. 13 illustrates an exemplary physical server system 710 as employed by embodiments of the present disclosure. An embodiment may employ a physical server to manage inventory 200, manage the emotional score collection and the advertisements that correspond to emotional values. The initial emotional score for each product may be assigned by the manufacturer 201, and may be stored with the inventory information within the e-tailer's databases. The advertising database 240 may track various data for advertisements, such as which emotion and demographic the advertisement is targeted towards, the base cost of the advertisement and the adjusted cost of the advertisement. The present disclosure allows for the price of an advertisement to evolve based on the advertisement's conversion to sales percentage. Some embodiments may perform calculations to determine advertisement price.

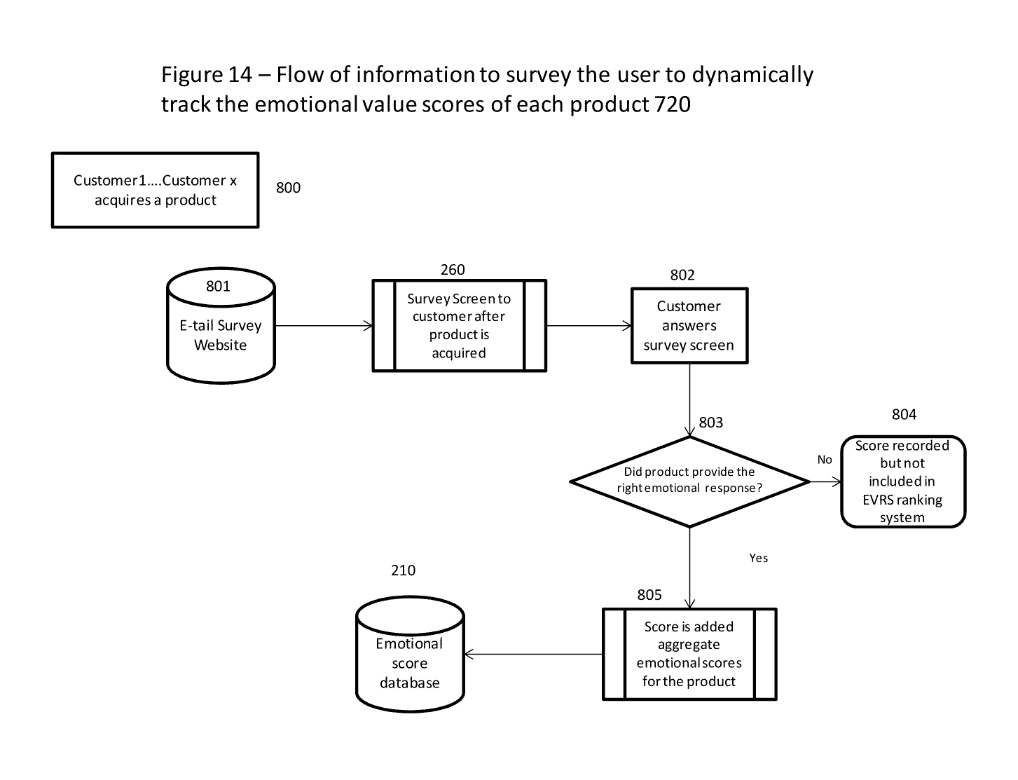

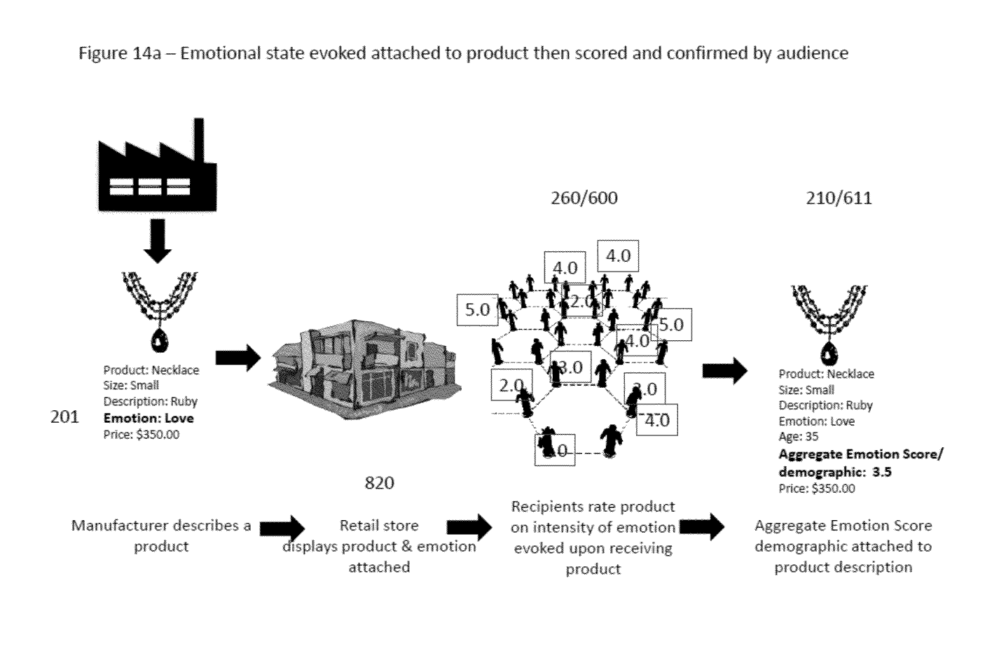

FIG. 14 illustrates an exemplary process of the present disclosure for dynamically score adjustment of the emotional value for each product purchased. A filter may be put into place for eliminating, or reducing the impact of product purchases for the wrong emotion. In some embodiments, the e-tail store may survey customers who have received the product to determine the emotional state each customer experienced and the emotional impact score each customer experienced 801. In one arrangement, this may be achieved by providing to recipients ana interactive survey for completion and return. The customers complete the survey and the information is received by the e-tail store 802. In some embodiments, an application within the e-tail stores ordering and surveying system 803 may determine whether the product elicited the predicted emotional response in the recipient. In one embodiment, if the recipient does not respond with the predicted emotion, the emotional impact scores are not included in the aggregate emotional value ranking system scores for the product 804. If the emotion experienced by the recipient is the correct emotion, that customer's emotional value impact score may be added to the aggregate emotional scores for that product 805. These aggregate scores may be further classified per the demographics of the recipient and may be recorded in the emotional store database 210. In some embodiments, the manufacturer's original predicted emotion may be eventually recipient data, may be weighted towards recipient data, or may be weighted towards manufacturer input.

FIG. 14A illustrates an overview of an exemplary process for aggregate emotion score to be developed from many purchases of a product or service. The manufacturer declares which specific emotion the product should elicit from a recipient in addition to other elements of the product description 201. This information travels to the e-tail server to be used by the e-tail entity's Catalog Management System (CMS) 210.1. Recipients of the product provide information regarding emotional impact the product or service had on them 260/600. The e-tail store can then display to buyers who have entered the emotion they desire to see in the recipient and demographic information. The e-tail then returns products which have the highest aggregate score of causing that emotion for that demographic.

One embodiment may provide products and services that provide the desired emotional impact for a chosen demographic. One embodiment may provide products and services that provide the predicted emotional impact for a chosen demographic

One embodiment may augment a product's or service's brand identity by recognizing the emotional impact for a chosen demographic. One embodiment may augment a product's or service's brand identity by measuring the emotional impact for a chosen demographic. One embodiment may augment a product's or service's brand identity by evaluating the emotional impact for a chosen demographic. One embodiment may augment a product's or service's brand identity by recognizing, measuring and evaluating the emotional impact for a chosen demographic.

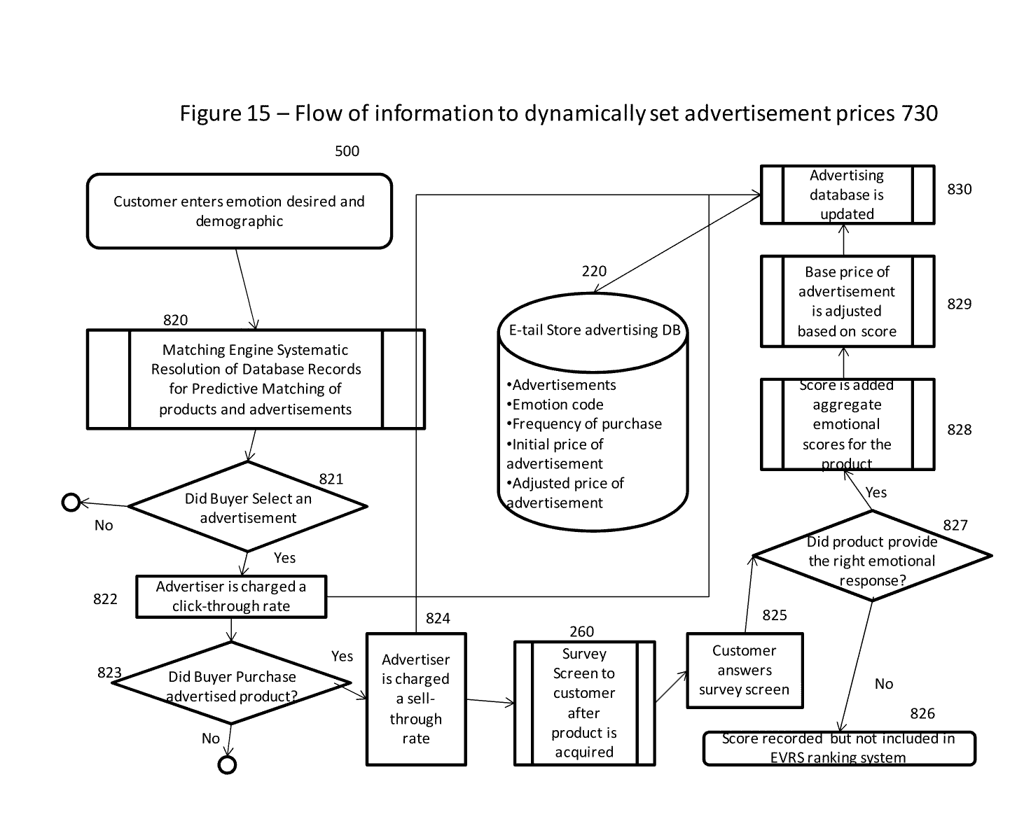

FIG. 15 illustrates an exemplary process for dynamical price advertisements so that the advertisements of products that score the highest in causing the preferred emotion in the recipient dynamically change and illustrates how user surveys may affect advertisement pricing 730. In some embodiments, as a user searches for a product that elicits a certain emotional response within a certain demographic, an embodiment may provide both a listing of products which meet the user's criteria and advertisements for products that obtained the highest scores for conveying that desired emotion. The advertisements may be chosen by the disclosed subject matter similarly to the products that are shown—the higher the emotional value score of the product advertised, the more often that particular advertisement may be shown in response to the search criteria (e.g. desired emotion and demographics). Because the advertisements may be correlate to a user's particular emotional goal for the chosen demographic, there may be an increased likelihood the advertisement will result in a purchase. A high frequency of advertisement that leads to purchase and a high emotional score ranking may create a higher ROI on the advertisement and therefore becomes a more valuable advertisement. An exemplary process of dynamically pricing advertisements is as follows. A buyer desires a product that will evoke a particular emotion in the recipient. An embodiment of an ordering system may provide an online interface that allows the buyer to enter some demographics about the recipient (e.g. age and sex) and the emotion the buyer would like the recipient to have upon receiving the product (e.g. a feeling of success or a feeling of being nurtured) 500. An embodiment's search engine searches its inventory database and its advertisement database 820 and returns the products with the highest aggregate score within the Emotional Value Ranking System for the entered demographic and some advertisements from the advertisement database. An embodiment's search engine may select the advertisements that rank the highest as conveying the specific emotion for the demographics entered. An advertisement that is selected by the buyer 821 may be charged a click-through rate 822, which may entered into the advertisement database 220. This means that the advertisement caught the attention of the user and the advertiser received value. Next the application 823 determines if the user purchased the advertised product. If the user purchases the advertised product 824, the advertiser receives more value from the advertisement and so is charged the sell-through advertisement rate 824 which is noted in the advertisement database 220. The recipient may be sent a survey after the product is received 260 to ascertain the emotional value the recipient received from the product and to score its emotional impact. If the recipient does not respond with the predicted emotion, the emotional impact scores are not included in the aggregate emotional value ranking system scores for the product 826. If the emotion experienced by the recipient is the correct emotion 827, that recipient's emotional value impact score may be added to the aggregate emotional scores for that product 828. The base price of the advertisement may be adjusted once more based on the product having the right emotional response 829. Other embodiments related to product scoring could also be implements with respect to updating the advertising emotional value. Finally, the advertising database is updated with the new price for the advertisement 220 carrying forth the aggregation that the products that most successfully convey the impact of the desired emotion are offered to buyers.

What is claimed is:

1. A method for providing products and services that provide a predicted emotional impact for a demographic, the method comprising:
via a processor, determining from data stored in a database an Evoking Value (EV) for a product or service (P/S) and an emotional state (ES), said ES being a subset of a plurality of pre-selected emotional states;
said data in a database comprising information, said information consisting of at least one of the following:
an aggregated difference in an initial emotional state and a post emotional state;
said initial emotional state being a subset of a plurality of pre-selected emotional states, said initial emotional state associated with an emotional state before receiving said P/S;
said post emotional state being a subset of a plurality of pre-selected emotional states, said post emotional state associated with an emotional state after receiving said P/S;
an aggregated difference in an initial emotional score value and a post emotional score value;
said initial emotional score value measuring an intensity of said initial emotional state;
said post emotional score value measuring an intensity of said post emotional state; and
via an electronic interface, receiving a selection of a desired emotional state (DES) from a first computer, said selection of a DES selected from a plurality of pre-selected ES;
via an electronic interface, searching said database for said selection of a DES and identifying at least one P/S having an EV for said DES matching said selection,
via an electronic interface, transmitting information associated with said identified at least one P/S having said EV to a first computer, said information comprising general information for each of said at least one P/S identified and an EV for each of said at least one P/S identified, and
via a display of said first computer, displaying one or more of said identified P/S.
wherein P/S that are determined to be more effective at eliciting an emotional response will be presented at a greater frequency when compared to P/S that are determined to be less effective at eliciting an emotional response.

2. The method of claim 1, further comprising:
via an electronic interface receiving demographic information associated with a second computer;
via said database, storing said demographic information;
wherein said demographic information includes at least a gender value and an age range value; and
wherein said Evoking Value determination comprises said demographic information.

3. The method of claim 2, further comprising:
via an electronic interface, receiving demographic information associated with said first computer, said demographic information associated with said first computer includes at least a relationship indicator; and
wherein said Evoking Value determination comprises said demographic information.

4. The method of claim 1, wherein said EV is adjusted according to the standard deviation between said initial emotional score and said post emotional score.

5. The method of claim 1,
via a electronic interface, providing said survey in response to receiving a unique identifier from said second computer, said unique identifier identifying at least a received P/S, said DES, demographic information associated with said second computer, and demographic information associated with said first computer.

6. The method of claim 1, wherein said determination of said EV further comprises information on:
a purchase frequency, said purchase frequency the number of times a particular subset of P/S is purchased associated with said DES;
a query frequency, said query frequency the number of times a particular subset of P/S is purchased associated is one of said identified P/S; and

[symbol]

7. The method of claim 1, further comprising:
via a processor, querying advertisement stored in a database;
via said processor identifying a subset of advertisements for P/S having a EV value correlating to said query requirements;
via a electronic interface, transmitting at least one of said identified advertisements to said first computer, said at least one advertisement including said EV for said P/S;
wherein transmission of said transmitting at least one of said identified advertisements to said first computer incurs a fee request transmitted to a third computer.

8. The method of claim 1, further comprising:
via a network interface, providing a survey to a second computer, said survey related to at least one of said products and/or services;
via said network interface, receiving response values from said second computer, wherein said response values include at least:
an initial emotional state, said initial emotional state being a subset of a plurality of pre-selected emotional states, said initial emotional state associated with an emotional state before receiving said P/S;
an initial emotional score, said initial emotional score related to the intensity of said initial emotional state;
a post emotional state, said post emotional state being a subset of a plurality of pre-selected emotional states, said post emotional state associated with an emotional state after receiving said P/S;
a post emotional score, said post emotional score related to the intensity of said post emotional state; and
via a processor, determining a second EV for a product or service (P/S) and an emotional state (ES), said determining comprising received response values.

9. The method of claim 8, wherein determining said second EV requires said post emotional state to match said desired emotional state.

10. The method of claim 8, further comprising:
via a processor, determining said second EV according to the standard deviation between said initial emotional score and said post emotional score.

11. The method of claim 8, further comprising:
via a processor determining presence of a unique identifier for said second computer, said unique identifier for said second computer comprising:
a purchased P/S, and
a desired emotional state; and
via a network interface, transmitting said survey to said second computer.

12. A method for providing insight into perceived satisfaction for gift purchases for a chosen demographic by aggregating scoring for a positive emotion value conveyed upon receipts of a products or services, the method comprising:
receiving a desired emotional state from a purchaser, wherein said desired emotional state is the desired emotional state said purchaser desires to evoke in a recipient, wherein said desired emotional state is received via a communications medium;
searching a database of products and/or services to identify products and/or services that have been proven via the emotional scoring method are expected to evoke said desired emotional state, said database of products and/or services stored on a computer readable medium;
transmitting information associated with said identified products and/or services to said purchaser, said information including general information for each of said identified products and/or services and an emotional value score for each of said identified products and/or services, said emotional value score based on the likelihood that each of said identified products and/or services will evoke said desired emotional state in said recipient when said recipient receives said product and/or service;
permitting said purchaser to purchase one or more of said identified products and/or services for said recipient.

13. The method of claim 12, additionally comprising the following steps:
receiving recipient demographic information from said purchaser, said recipient demographic information relating to said recipient and received via said communication medium, wherein said recipient demographic information includes at least a gender and an age range; and
wherein said emotional value score is also based on said recipient demographic information.

14. The method of claim 13, additionally comprising the following steps:
receiving purchaser demographic information from said purchaser, said purchaser demographic information relating to said purchaser and received via said communication medium, wherein said purchaser demographic information includes at least a relationship indicator, said relationship indicator indicating said purchaser's relationship with said recipient; and
wherein said emotional value score is also based on said purchaser demographic information.

15. The method of claim 14 to update the currently known emotional value score of a product or services emotional value impact by collecting information from the recipient, additionally comprising the following steps:
providing a survey to each said recipient, said survey related to at least one of said products and/or services purchased for said recipient by said purchaser;
receiving responses from said recipient via said communications medium, wherein said responses include at least:
an initial emotional state of said recipient, said initial emotional state the emotional state of said recipient before receiving said purchased products and/or services;
an initial emotional score of said recipient, said initial emotional score related to the intensity of said initial emotional state;
a post emotional state of said recipient, said post emotional state the emotional state of said recipient after receiving said purchased goods and/or services; and
a post emotional score of said recipient, said post emotional score related to the intensity of said post emotional state; and
adjusting said emotional value score associated with said post emotional state, said recipient demographics, and said purchaser demographics according to the difference between said initial emotional score and said post emotional score.

16. The method of claim 15, wherein said emotional value score is adjusted according to the standard deviation or measure of impact of emotion on recipient between said initial product's emotional value score and said post emotional value score of said recipient.

17. The method of claim 15 to aggregate emotional score of universe within each e-tailer recipients of said product, wherein said survey is provided in response to receiving a unique identifier from said recipient via said communications medium, said unique identifier identifying at least said purchased goods and/or services, said desired emotional state, said recipient demographics, and said purchaser demographics.

18. The method of claim 13, wherein said emotional value score is generated with:
a purchase frequency, said purchase frequency the number of times a particular one of said products and/or services is purchased in response to said desired emotional state;
a query frequency, said query frequency the number of times said particular one of said products and/or services is one of said identified products and/or services; and
a delta amount, said delta amount the difference between:
an initial emotional state of said recipient, said initial emotional state the emotional state of said recipient before receiving said purchased products and/or services; and
a post emotional score of said recipient, said post emotional score related to the intensity of said post emotional state

[symbol]

19. The method of claim 13 to entice the buyer towards gifts with proven history of success and generate the most profit for the e-tailer by dynamically pricing advertisements with the highest Return on Investment (ROI), additionally comprising the following steps:
searching an advertising database to identify advertisements for products and/or services expected to evoke said desired emotional state, said advertising database stored on said computer readable medium, wherein each of said advertisements in said advertising database is associated with at least one advertiser;
transmitting at least one of said identified advertisements to said purchaser, said at least one advertisement including said emotional value score for said products and/or services being advertised, said identified advertisements transmitted via said communications medium;
charging a price to each of said advertisers associated with at least one of said transmitted advertisements;
permitting said purchaser to purchase on or more of said products and/or services corresponding to said transmitted advertisement for said recipient.

20. The method of claim 19, wherein at least one of said advertisements is received from said associated advertiser with an expected emotional state, said expected emotional state the emotional state said associated advertiser believes the advertised product and/or service will evoke in a recipient.
